(19) United States
(12) Patent Application Publication
(10) Pub. No.: US 2021/0257119 A1
(43) Pub. Date: Aug. 19, 2021

(54) UNVENTILATED CASK FOR STORING NUCLEAR WASTE

(71) Applicant: HOLTEC INTERNATIONAL, Camden, NJ (US)

(72) Inventor: Krishna P. SINGH, Jupiter, FL (US)

(73) Assignee: HOLTEC INTERNATIONAL, Camden, NJ (US)

(21) Appl. No.: 17/165,224

(22) Filed: Feb. 2, 2021

Related U.S. Application Data
(60) Provisional application No. 62/969,183, filed on Feb. 3, 2020.

(51) Int. Cl. G21F 5/008; G21F 5/12; G21F 5/06

(52) U.S. Cl. CPC G21F 5/008; G21F 5/065; G21F 5/12

(57) ABSTRACT

A nuclear waste fuel storage system includes an unventilated cask including inner and outer shells, an annular space between the shells containing radiation shielding, and sealed baseplate. Threaded anchor bosses are affixed to the top end of the cask. A heavy free-floating radiation shielding lid is loosely coupled the top end of the cask in a movable manner via the anchor bosses by bolt assemblies which loosely secure the lid to the cask. An internal cavity of the cask which holds a nuclear waste fuel canister is sealed by an annular gasket compressed between the lid and cask, thereby forming a gas tight pressure vessel operable to retain internal pressures exceeding atmospheric. During a cask overpressurization condition, the lid automatically moves between a normal downward sealed position on the cask to an installer-adjustable raised relief position ajar from the cask to relieve excess pressure to atmosphere.

### CROSS-REFERENCE TO RELATED APPLICATIONS

This application claims the benefit of U.S. Provisional Application No. 62/969,183 filed Feb. 3, 2020, which is incorporated herein by reference in its entirety.

### BACKGROUND

The present invention relates generally to systems and vessels for storing high level radioactive nuclear waste such as used or spent nuclear fuel (SNF), and more particularly to an improved unventilated storage cask system for storing nuclear waste.

In the operation of nuclear reactors, the nuclear energy source is in the form of hollow Zircaloy tubes filled with enriched uranium, collectively arranged in multiple assemblages referred to as fuel assemblies. When the energy in the fuel assembly has been depleted to a certain predetermined level, the used or “spent” nuclear fuel (SNF) assemblies are removed from the nuclear reactor. The standard structure used to package used or spent fuel assemblies discharged from light water reactors for off-site shipment or on-site dry storage is known as the fuel basket. The fuel basket is essentially an assemblage of prismatic storage cells each of which is sized to store one fuel assembly that comprises a plurality of individual spent nuclear fuel rods.

The fuel basket is arranged inside a cylindrical metallic nuclear waste fuel canister, which is often referred to as a multi-purpose canister (MPC). Such MPCs are available from Holtec International of Camden, N.J. The fuel assemblies are typically loaded into the canister while submerged in the spent fuel pool of the reactor containment structure to minimize radiation exposure to personnel.

An essential attribute of such a fuel storage MPC is that it is designed and manufactured to provide safe radiological confinement to its contents and satisfies the criterion of “leak tight” (against particulate and gaseous radiological matter) as defined in the USNRC regulatory guidance documents. Such a waste package, however, is not autonomously capable of providing protection against neutrons and gamma radiation emanating from its contents which would, if exposed to biological life would be deadly. Therefore, the MPC needs to be stored in a heavily radiation-shielded outer cask that permits as little radiation as possible to escape to the environment. The storage cask must also be able to transmit and dissipate the decay heat generated inside the MPC by the decaying fuel assemblies to the ambient environment. Effective heat rejection and effective reduction of radiation are thus the twin functions of the storage cask, also referred to in the industry as an “overpack” or “storage module.”

The storage cask used to store the loaded canister has historically been in the form of a ventilated cask wherein ambient ventilation air enters the cask near the bottom and exits near the top thereby convectively removing heat emitted by the canister. Ventilated cask designs are widely used for storing nuclear waste fuel canisters with aggregate heat loads as high as 50 kW. However, such ventilated cask suffer from one potential vulnerability in marine environments where the salt-laden ambient ventilation air can induce stress corrosion cracking (SCC) in the canister's austenitic stainless-steel confinement boundary. SCC is a well-documented problem encountered in the nuclear fuel storage industry. Ventilated overpacks also need to be surveilled regularly to ensure that their vent passages are not blocked which an diminish heat rejection from the cask.

Accordingly, there remains a need for an improved nuclear waste storage cask that provides the necessary heat dissipation and radiation blockage functions, but eliminates the risk of initiating stress corrosion cracking on the exterior surfaces of the waste fuel canister inside the cask.

### BRIEF SUMMARY

The present application discloses a radiation-shielded unventilated nuclear waste storage cask with heat dissipation system which effectively removes decay heat emitted from the nuclear waste fuel canister housed therein. In one embodiment, the cask comprises an inner shell, outer shell, and plurality of radial rib plates connected between the shells which convey heat away from the canister through the walls of the cask to the ambient environment. The outer shell is cooled by convection via ambient airflow and radiation effects. Radiation shielding is provided in the annulus between the shells and the rib plate therein. The rib plates further structurally reinforced the cask and play a role in lifting the cask, as further described herein.

In contrast to the typical ventilated storage casks discussed above, the present unventilated storage cask is hermetically sealed forming a pressure retention vessel configured to contain pressures in excess of atmospheric pressure. Because there is no ambient air exchanged with the sealed internal cavity of the unventilated storage cask in which the waste fuel canister is stored, the risk of initiating stress corrosion cracking (SCC) of the canister is effectively mitigated. The unventilated storage cask also includes a safety feature comprising a pressure relief mechanism to relieve the buildup of excessive pressure within the pressure vessel class cask. Excess pressure is safely released to atmosphere by a unique floating lid to cask interface design which protects the structural integrity of the unventilated cask and waste fuel canister therein. When overpressurization conditions abate, the lid automatically reseals the cask cavity.

As its design configuration indicates, the unventilated storage cask has a considerably reduced heat load capacity compared to its ventilated counterpart. Because the only heat rejection pathway available in the present unventilated storage system is via conduction through the shells of the cask and natural convection/radiation at the cask's exterior surface to the ambient, the annulus gas inside the overpack will be at an elevated temperature. Because heating of air reduces its relative humidity and a high humidity content is necessary (but not sufficient) to induce stress corrosion cracking (SCC) in the austenitic stainless steel confinement boundary of the waste fuel canister, increasing the temperature of the air surrounding the canister in the internal cavity of the cask serves to prevent the onset of SCC under extended storage conditions. A preferred alternative is to replace the air within the annular area of the cask surrounding the canister with a non-reactive gas, such for example without limitation as nitrogen or argon. Preventing SCC in long term dry storage casks of the present design is one objective of the present unventilated nuclear waste fuel storage system.

If SCC is not a major threat in the nuclear waste fuel storage environment, then it is not necessary to purge the ambient air from the cask for replacement with an inert gas. In such a case, the air pressure in the hermetically sealed cavity of the unventilated storage cask will rise in temperature roughly in accordance with the perfect gas law. To provide pressure relief under a U.S. NRC (Nuclear Regulatory Commission) postulated accident scenario to which dry cask waste fuel storage systems must be designed, such as the cask's Design Basis Fire Event, the cask closure lid bolt assemblies are installed with a small vertical gap to loosely mount the lid to the cask body with a copious preset vertical travel clearance or gap to enable the lid to slideably lift up without frictional interference from the bolts. If the air pressure within the cask is high enough to lift the lid even by a minute amount, then some air will escape reducing the pressure within the cask back to normal operating pressures. Thus, the cask is a self-regulating and self-relieving device making uncontrolled overpressure impossible, as further described herein. In some embodiments, the internal design pressure of the cask may be set equal to approximately 200% of the pressure that will equilibrate the weight of the cask closure lid.

In one aspect, an unventilated nuclear waste fuel storage system comprises: a longitudinal axis; a canister configured for storing nuclear waste fuel inside; an outer cask comprising a cask body including an inner shell, an outer shell, an annular space containing a radiation shielding material formed between the shells, and a bottom baseplate sealed to bottom ends of the shells; a radiation shielding lid selectively sealable to the cask body, the lid when positioned on the cask body collectively defining a gas tight cavity receiving the canister; a plurality of longitudinal lifting rib plates extending radially between and fixedly attached to the inner and outer shells in the annular space, each lifting rib plate comprising a threaded anchor boss fixedly attached at a top end thereof; and a plurality of threaded bolt assemblies threadably engaged with the anchor bosses which secure the lid to the cask; wherein the gas tight cavity forms a pressure vessel operable to retain pressures above atmospheric pressure within the cask.

According to another aspect, an unventilated nuclear waste fuel storage pressure vessel with self-regulating internal pressure relief mechanism comprises: a longitudinal axis; a cask body including an inner shell, an outer shell, an annular space containing a radiation shielding material formed between the shells, a bottom baseplate sealed to bottom ends of the shells, and an internal cavity configured to house a nuclear waste fuel canister therein; a plurality of upwardly open threaded anchor bosses affixed to a top end of the cask body; a radiation shielding lid loosely coupled to the top end of the cask body in a movable manner; an annular compressible gasket forming a circumferential seal between the lid and the top end of the cask body which renders the cavity gas tight; and a plurality of bolt assemblies passing through the lid and threadably engaged with the anchor bosses, the bolt assemblies configured and operable to loosely secure the lid to the cask body; the lid being movable between (1) a downward sealed position engaged with the cask body which seals the gas tight cavity of the cask; and (2) an adjustable raised relief position engaged with the bolt assemblies but ajar from the top end of the cask body to partially open the gas tight cavity thereby defining a gas overpressurization relief passageway to ambient atmosphere; wherein the cask is operable to retain an internal pressure within the cavity above atmospheric pressure.

According to another aspect, a method for protecting an unventilated nuclear waste storage system from internal overpressurization comprises: providing an unventilated cask comprising a sealable internal cavity and a plurality of threaded anchor bosses; lowering a canister containing high level nuclear waste into the cavity; positioning a radiation shielded lid on the cask, the lid being in a downward sealed position engaged with the cask making the cavity gas tight to retain pressures exceeding atmospheric; aligning a plurality of fastener holes formed in the lid with the anchor bosses; threadably engaging a threaded stud with each of the anchor bosses through the fastener holes of the lid; rotatably engaging a threaded limit stop with each of the threaded studs; positioning the limits stops on the studs such that a vertical travel gap is formed between the lid and the limit stops; wherein during a cask overpressurization condition, the lid slideably moves upward along the studs to a relief position ajar from the cask to vent excess pressure to atmosphere.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein like elements are labeled similarly and in which:

FIG. 1 is perspective view of a pressure vessel in the form of an unventilated cask for nuclear waste fuel storage according to the present disclosure;

FIG. 2A is a partial cross sectional view thereof;

FIG. 2B is an enlarge detail taken from FIG. 2A;

FIG. 3 is a top view of the cask;

FIG. 4 is a longitudinal cross sectional view of the cask taken from FIG. 3;

FIG. 5A is an enlarged detail showing the closure lid to cask interface and mounting details for securing the lid to the cask in a free floating manner, the lid being shown in a downward sealed position;

FIG. 5B is a similar view to FIG. 5A, but showing the lid in a raised pressure relief position ajar from the cask;

FIG. 5C is a similar view to FIG. 5A, but showing one of the lid bolt assemblies in exploded view;

FIG. 6 is a longitudinal cross sectional view of the cask taken from FIG. 3;

FIG. 7 is a partial cross-sectional view of the cask closure lid;

FIG. 8 is an enlarged detail taken from FIG. 7,

FIG. 9 is a transverse cross sectional view of the lid;

FIG. 10 is an exploded perspective view of the cask;

FIG. 11 is a side elevation view of the cask;

FIG. 12 is a side elevation view thereof showing parts of the cask closure lid in exploded view;

FIG. 13 is a partial longitudinal cross sectional view of the cask showing the nuclear waste fuel canister positioned in the internal cavity of the cask;

FIG. 14 is a perspective view of one of the lifting rib plates of the cask configured for use with the lid bolt assembly;

FIG. 15 is a bottom exploded perspective view of the lid and upper portion of the cask; and

FIG. 16 is a top exploded perspective view of the lid and upper portion of the cask.

All drawings are schematic and not necessarily to scale. Features shown numbered in certain figures which may appear un-numbered in other figures are the same features unless noted otherwise herein. A general reference herein to a figure by a whole number which includes related figures sharing the same whole number but with different alphabetical suffixes shall be construed as a reference to all of those figures unless expressly noted otherwise.

### DETAILED DESCRIPTION

The features and benefits of the invention are illustrated and described herein by reference to non-limiting exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, any references cited herein are hereby incorporated by reference in their entireties. In the event of a conflict in a definition in the present disclosure and that of a cited reference, the present disclosure controls.

The terms “seal weld or welding” as may be used herein shall be construed according to its conventional meaning in the art to be a continuous weld which forms a gas-tight hermetically sealed joint between the parts joined by the weld. The term “sealed” as may be used herein shall be construed to mean a gas-tight hermetic seal.

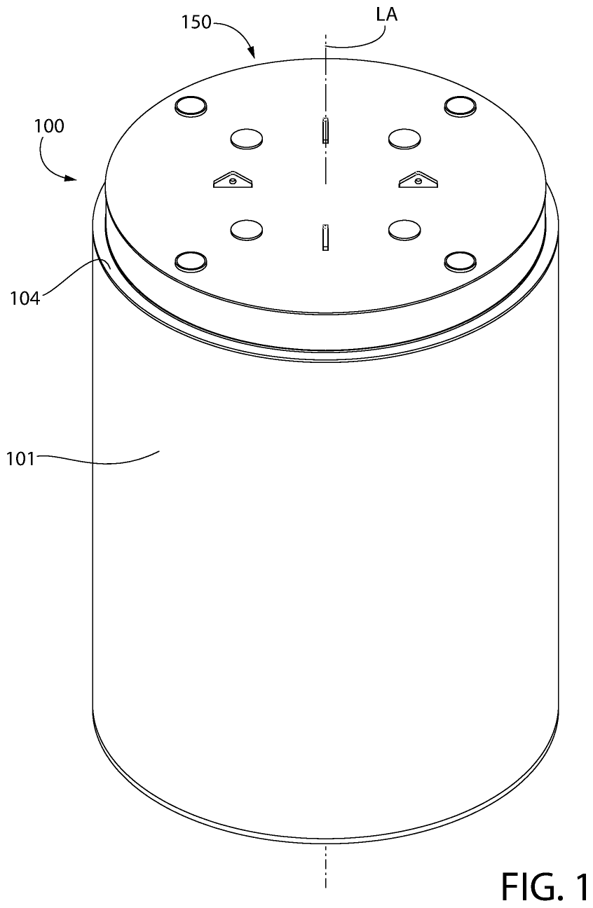

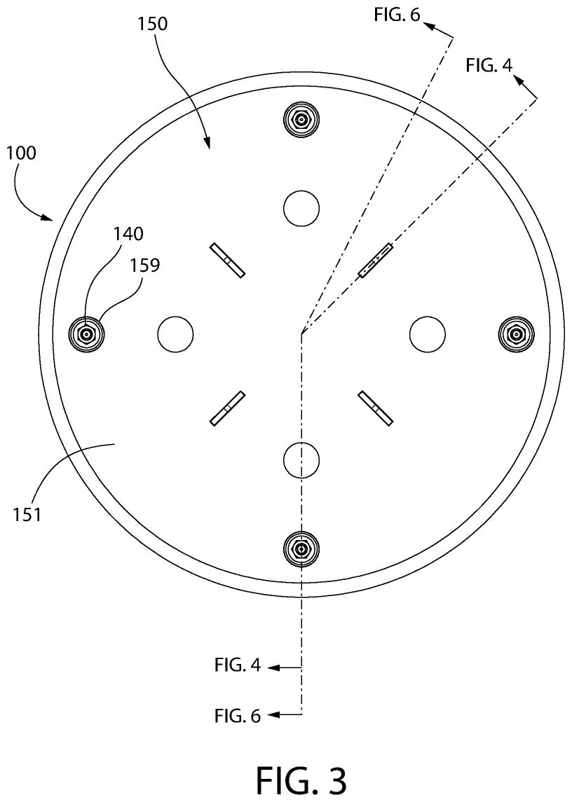

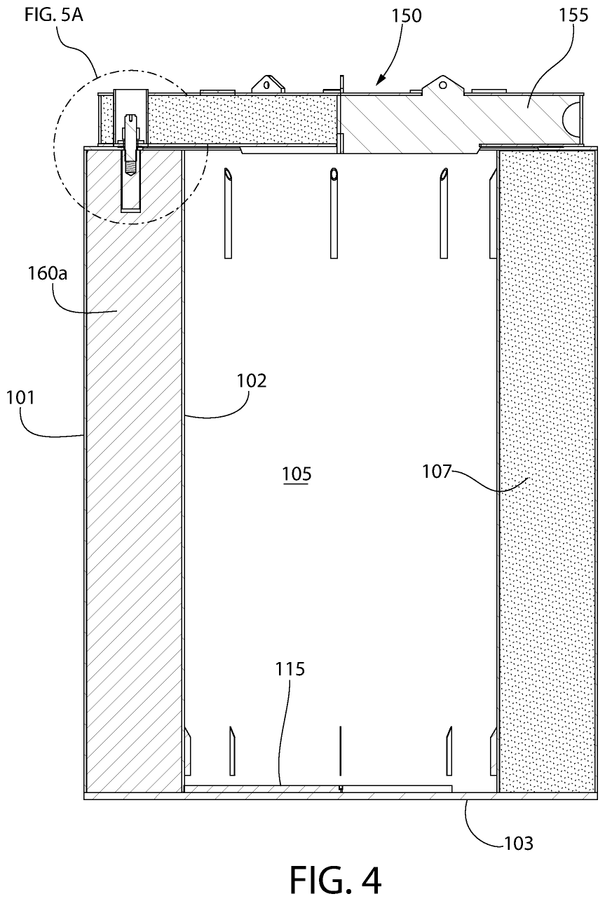

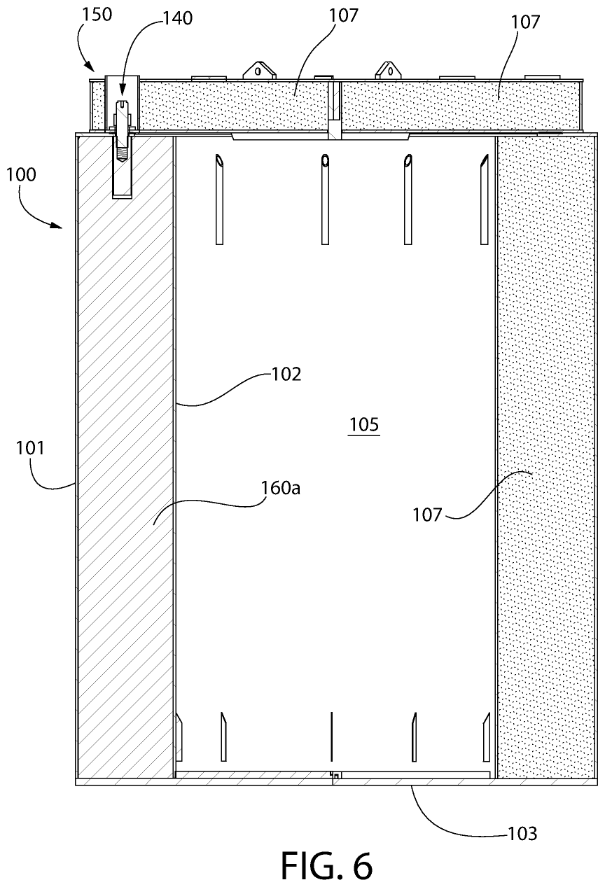

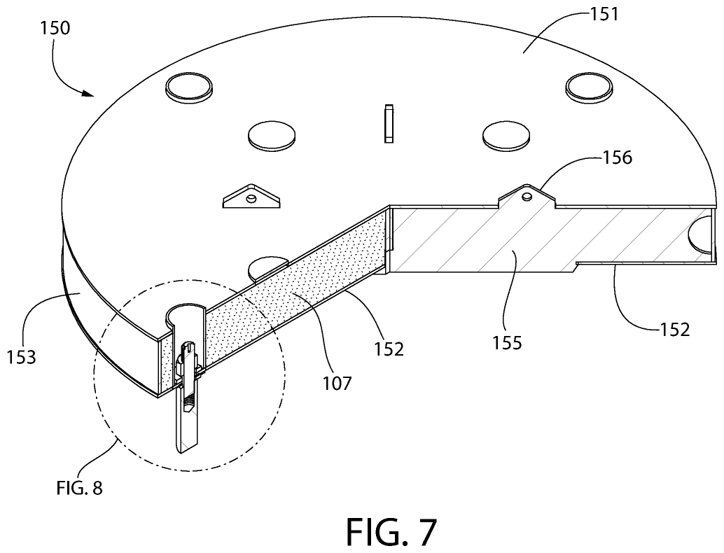

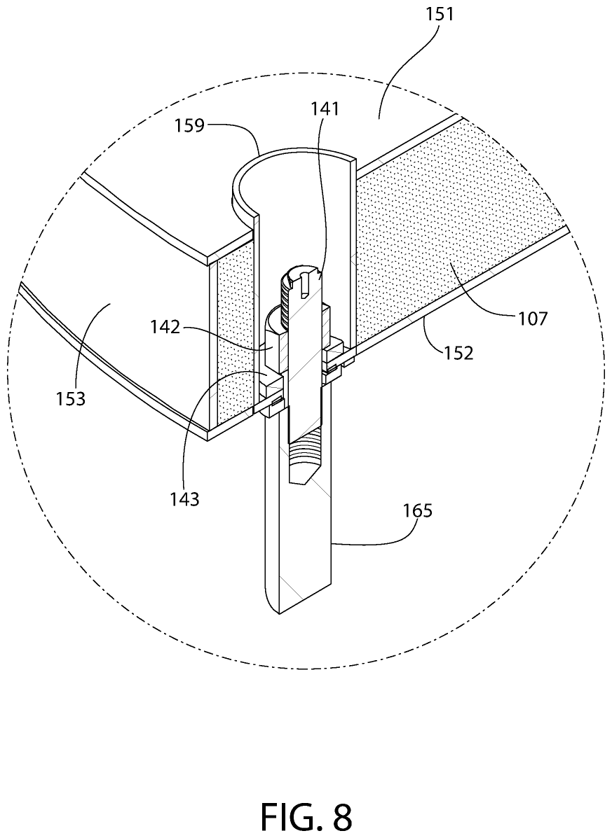

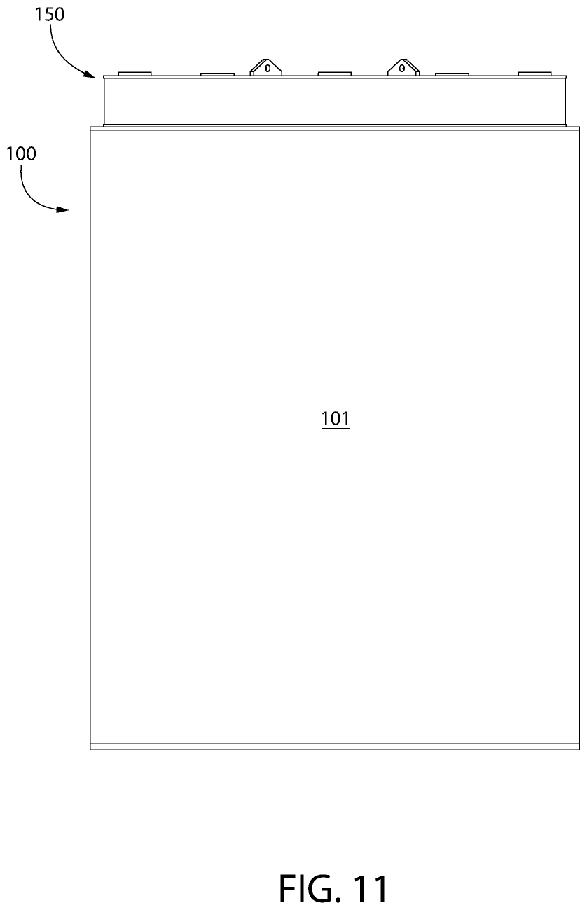

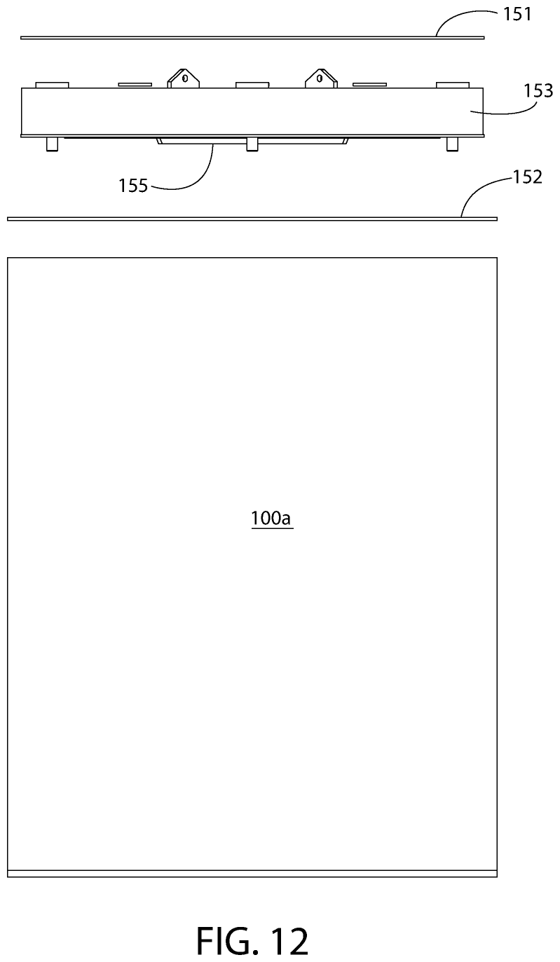

FIGS. 1-16 show various aspects of the nuclear fuel storage system comprising an unventilated nuclear fuel storage pressure vessel with a self-regulating pressure relief mechanism and integral heat dissipation system. The nuclear fuel storage system in one embodiment generally comprises a pressure vessel in the form of an outer unventilated storage cask 100 and a high level radioactive nuclear waste (e.g., SNF) canister 120 configured for storage inside the cask. Features of each storage vessel and other features thereof will now be further described.

Canister 120 may be used for storing any type of high level radioactive nuclear waste, including without limitation spent nuclear fuel (SNF) or other forms of radioactive waste materials removed from the reactor. The SNF or simply fuel canister for short may be any commercially-available nuclear waste fuel canister, such as a multi-purpose canister (MPC) available from Holtec International of Camden, N.J. or other.

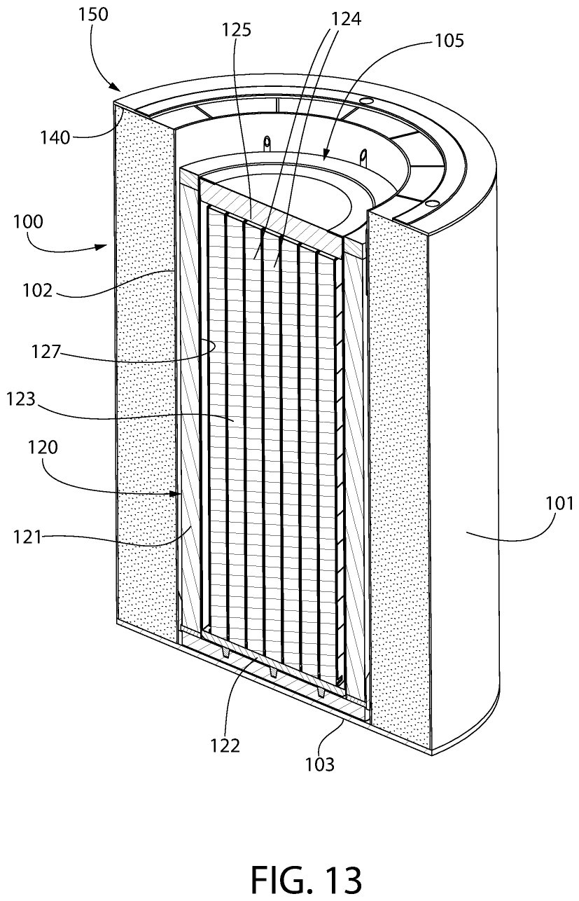

Referring momentarily to FIG. 13, waste fuel canister 120 has a vertically elongated and metallic body comprised of a cylindrical shell 121. Canister 120 further includes a bottom baseplate 122 seal welded to a bottom end of the shell, and an open top closed by an attached lid 125. Lid 125 may be seal welded to a top end 126 of the canister shell 121 to form a hermetically sealed cavity 127 inside the canister. The foregoing canister parts may be formed of any suitable metal, such as for example without limitation steel including preferably stainless steel for corrosion protection.

Fuel basket 123 is disposed in cavity 127 of the canister 120 and is seated on the bottom baseplate 122 as shown. The fuel basket may be welded to the baseplate for stability in some embodiments. In some embodiments, the baseplate 122 may extend laterally outwards beyond the sides of the fuel basket 123 around the entire perimeter of the fuel basket as shown.

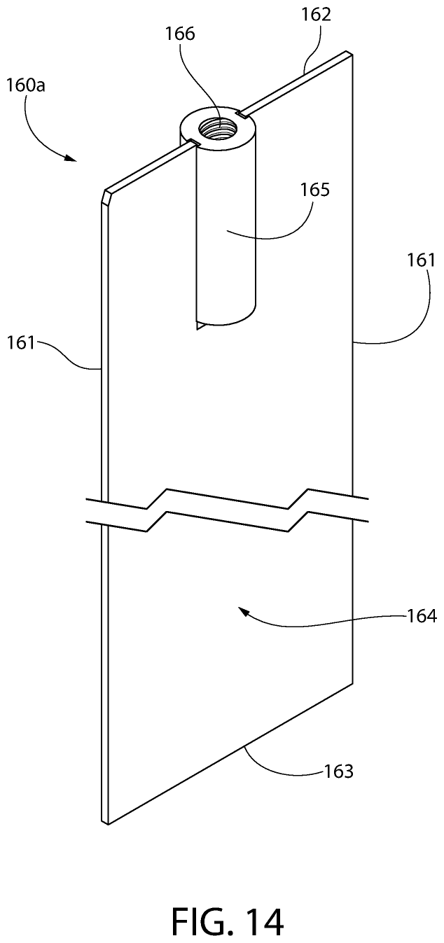

The fuel basket 123 is a honeycomb prismatic structure comprising an array of vertically-extending openings forming a plurality of vertical longitudinally-extending fuel assembly storage cells 124. Each cell is configured in cross-sectional area and shape to hold a single U.S. style fuel assembly, which contains multitude of spent nuclear fuel rods (or other nuclear waste). An example of fuel assembly of this type having a conventional rectilinear cross-sectional configuration is shown in FIG. 14 of U.S. patent application Ser. No. 17/132,102 filed Dec. 23, 2020, which is incorporated herein by reference. Such fuel assemblies and the foregoing fuel basket structure are well known in the industry. The fuel basket may be formed in various embodiments by a plurality of interlocked and orthogonally arranged slotted plates built up to a selected height in vertically stacked tiers. Other constructions of fuel baskets such as via joining multiple vertically extending tubes or other structures to the canister baseplate may be used and others used in the art may be used. The fuel basket construction is not limiting of the present invention.

With continuing reference to FIGS. 1-16, the unventilated storage cask 100 in one embodiment is a double-walled pressure vessel comprising a vertically elongated metallic cylindrical body 100a defining a vertical longitudinal axis LA passing through the vertical centerline and geometric center of the body. The cask body is an annular structure including an outer shell 101, an inner shell 102 spaced radially inwards therefrom and defining an annular space 106 between the shells, a circular bottom baseplate 103 coupled to the bottom ends of the shells, and an annular top closure plate 104 coupled to the top ends of the shells. The shells are arranged coaxially relative to one another. Baseplate 103 may be fixedly attached to the top and bottom ends of the shells preferably by via seal welding to form a hermetic bottom seal of the cask body. Accordingly, continuous circumferential seal welds may preferably be used to permanently join the bottom baseplate 103 to the shells 101, 102.

The circumferential outer edge 104b of top closure plate 104 may be welded to a top end of the outer shell 101 of the cask 100. The top closure plate has a radially broadened ring-like plate structure which projects radially inwards from the outer shell towards the inner shell 102. In one embodiment, as shown, top closure plate 104 projects radially inwards towards but does not contact or engage the inner shell 102 of the cask 100 to partially close the annular space 106 at top between the shells of the cask body. This arrangement provides additional space for a pressure release/relief passageway to quickly release excess pressure from the cask in the event of an internal cask overpressurization condition, as further described herein.

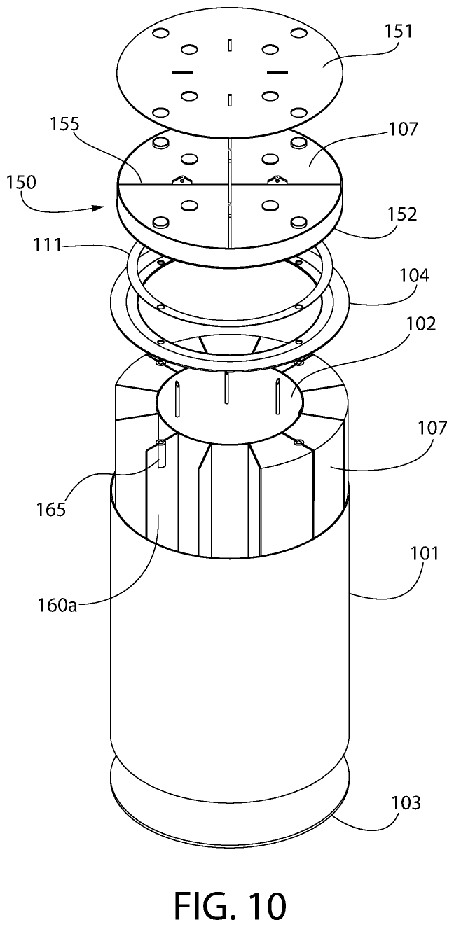

With particular emphasis on FIGS. 10 and 15-16, the top closure plate 104 of cask 100 comprises a plurality of fastener holes 109 which receive bolt assemblies 140 therethrough to threadably engage circumferentially spaced anchor bosses 165 fixedly mounted to the top end of the cask body 100a, as further described herein. Fastener holes 109 are circumferentially spaced apart along a bolt circle of suitable diameter. In one embodiment, fastener holes 109 may be circular and formed through an annular recessed gasket seating surface 110 formed on the inner annular portion of the top closure plate 104. The raised outer annular portion 113 of the top closure plate may be flat and plain as shown without openings. A compressible annular gasket 111 containing circumferentially spaced apart circular fastener apertures 112 is received on gasket seating surface 110. When mounted thereon, fastener apertures 112 are concentrically alignable with fastener holes 109 of the cask top closure ring 104. Gasket 111 forms a circumferential hermetic seal between the lid 150 and top closure plate 104 of the cask body 100a. Any suitable natural or man-made compressible material (e.g., elastomeric, rubber, etc.) material suitable for the intended service conditions (e.g., temperature, pressure, environment, etc.) may be used.

The cask body 100a defines an internal cavity 105 which extends longitudinally for a full height of the cask from baseplate 103 at bottom to the top ends of outer and inner shells 101, 102. The cavity 105 is configured in dimension and transverse cross-sectional area to hold only a single fuel canister 120 in some embodiments, as is conventional practice in the art. Cavity 105 is hermetically sealed when lid 150 is mounted to the cask body 100a and may therefore be pressurized to pressures above atmospheric, thereby categorizing cask 100 as a pressure vessel for ASME code purposes. The stress field in the cask's pressure retention boundary may be qualified to the limits of Section III Subsection ND of the ASME Boiler and Pressure Vessel Code.

The cask 100 is a heavy radiation shielded nuclear waste fuel storage pressure vessel operable to ameliorate the gamma and neutron radiation emitted by the nuclear waste fuel canister 120 to safe levels outside the cask. Accordingly, annular space 106 formed between outer and inner shells 101, 102 is filled with appropriate radiation shielding material(s) 107. In some embodiments, the shielding material 110 may comprise plain or reinforced concrete. Concrete densities up to 230 pounds/cubic feet or more may be used. However other or additional shielding materials and combinations thereof may be used including without limitation lead, boron-containing materials, or a combination of these and/or other materials effective to block and/or attenuate gamma and neutron radiation emitted by the nuclear waste (e.g., fuel assemblies) stored in canister 120 when loaded into the cask 100. Any suitable types, thicknesses, and arrangement of shielding materials may be used to provide the necessary degree of shielding.

The outer and inner shell members 101, 102 of the cask 100 may be formed of a suitable metal such as for example without limitation painted steel. The top closure plate 104 and bottom baseplate 103 may similarly be formed of the same metal for welding compatibility and strength.

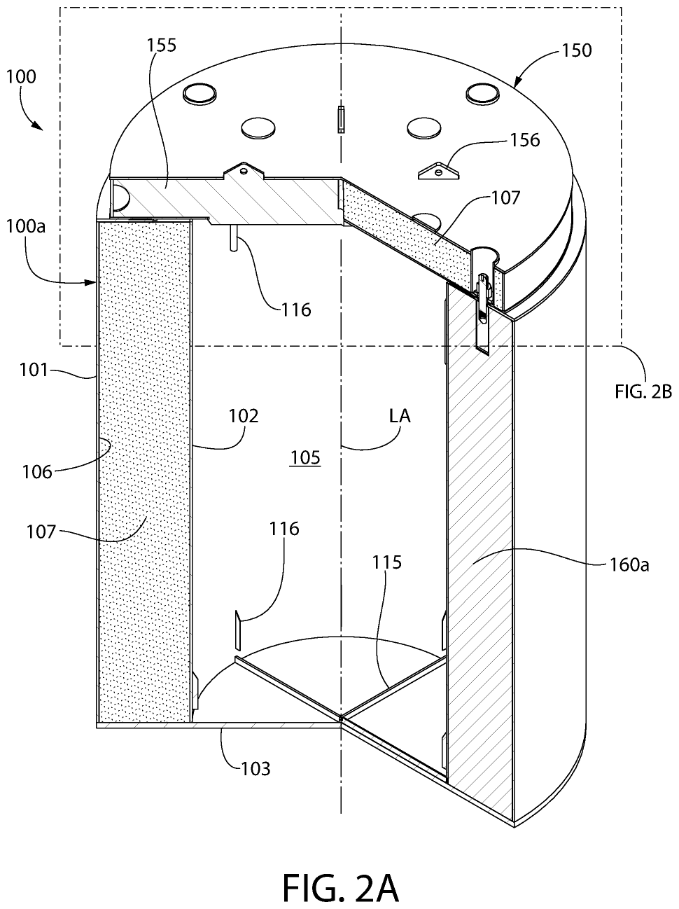

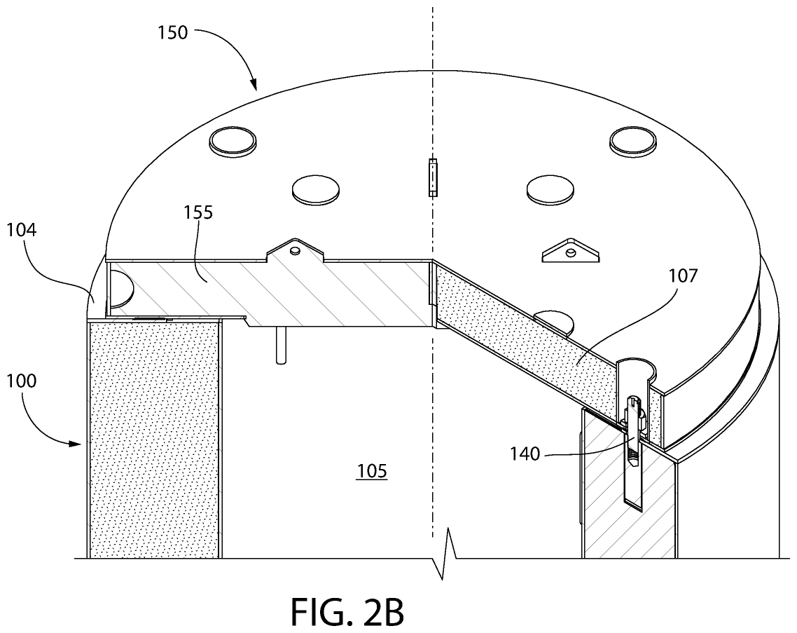

In one embodiment, a plurality of steel canister cross supports 115 may be welded to the top surface of the baseplate 103 (see, e.g., FIG. 2) inside internal cavity 105 to support the canister 120. The cross supports elevate the bottom of the canister above the baseplate. Cross supports 115 may be arranged in an intersecting X-pattern (cruciform) as shown; however, other suitable arrangements of the supports may be provided. In certain embodiments, a plurality of circumferentially spaced apart metallic seismic restraint tubes 116 may be welded to the interior surface of inner shell 102 inside cavity 105. The tubes keep the canister 120 centered and reduce radial/lateral movement during occurrence of a seismic event. A grouping of restraint tubes 116 may be provided in both the upper and lower portion of cask cavity 105 to restrain the top and bottom portions of the canister 120.

In contrast to vertical ventilated overpacks or casks, it bears noting that the present unventilated cask 100 has no provisions which allow for the exchange of ambient cooling air through the internal cavity 105 of the cask to cool the canister by natural thermo-siphon convective airflow. As previously noted herein, such ventilated cask designs may be unsuitable for storage of spent nuclear fuel (SNF) in a stainless steel canister within the cask in corrosive atmospheric environments and conditions. Many SNF canisters are made of austenitic stainless steel, which is susceptible to stress corrosion cracking (SCC) in humid corrosive environments in the presence of residual tensile surface stresses remaining from the fabrication of the canisters. In coastal environments, the presence airborne salts can be especially render a stainless steel SNF canister susceptible to chloride-induced SCC.

Because the internal cavity 105 of the present unventilated cask 100 is gas-tight and forms a pressure vessel, a heat dissipation mechanism is necessary to cool the canister within this hermetically sealed storage environment within the cask. In addition, further structural reinforcement of the cask's skeletal steel structure is desired to enable safe lift and transport of the cask with a motorized cask crawler in view of the heavy concrete laden cask body which can readily weight in excess of 100 tons.

To provide both additional structural strength to the cask and a heat transfer mechanism to cool the nuclear waste fuel canister 100 in cask 100, the cask may include a plurality of longitudinally-extending rib plates 160. FIG. 14 shows one form of rib plate 160a in isolation and greater detail which contains lid mounting bosses 165. Plain rib plates have a similar construction minus the mounting bosses, as further described below.

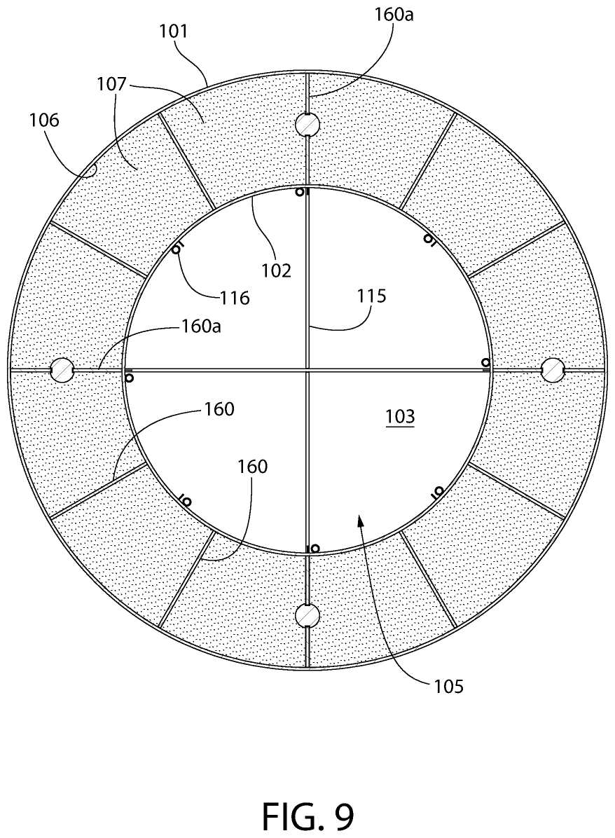

With continuing general reference to FIGS. 1-16, the longitudinal rib plates 160 are flat sheet-like rectangular structures disposed inside annular space 106 of cask 100 between the inner and outer shells 102, 101. The ribs plates are circumferentially spaced apart and welded along opposing longitudinal edges 161 of the plates to at least the inner and outer shells 102, 101. In one embodiment, longitudinally continuous fillet welds may be used which extend along the entire height of the rib plate to shells joint Rib plates 160 further include a top edge 162, bottom edge 163, and opposed flat and parallel major surfaces 164. The rib plates extend radially between the inner and outer shells 102, 101, and in some embodiments may be arranged in diametrically opposed pairs of plates (see, e.g., FIG. 9). Rib plates 160 extend for a full longitudinal height of the annular space 106 of the cask from the baseplate 103 to a top end of the cask body at the bottom surface of the top closure plate 104 (see, e.g., FIGS. 2A-B, 4, and 5A). In certain embodiments, the rib plates 160 may be welded at their top and bottom edges 162, 163 to the baseplate 103 and/or top closure plate 104 to further strengthen the cask skeletal structure. The circumnferential gaps formed between rib plates 160 within the annular space 106 are filled with the radiation shielding material 107, such as without limitation concrete.

It bears noting that the rib plates 160 each provide a conductive heat transfer path between the inner shell 102 and outer shell 101. The interior surface of inner shell 102 is heated by direct exposure to the waste fuel canister 120. The heat flows radially outward through the rib plates 160 via conduction to heat the outer shell 101, which then becomes hot and dissipates heat to the atmosphere via convective cooling and radiation.

Some of the rib plates 160 are configured to act as load transfer members used in lifting the cask 100. Accordingly, lifting rib plates 160a each comprise a threaded anchor boss 165 fixedly attached at a top end thereof (see, e.g., FIG. 14). Anchor boss 165 comprises a cylindrical body defining an upwardly open threaded bore 166 positioned to threadably engage a respective mounting bolt 140. assembly. The top of the mounting boss may be flush with the top edge 162 of the lifting rib plate in some embodiments as shown which allows the height of the rib plate to be maximized, which in turn maximizes its heat transfer capacity. A plurality of lifting rib plates 160a are preferably provided and spaced apart in circumferentially around the top end of the cask body. In the non-limiting illustrated embodiment, four lifting rib plates 160a are provided spaced 90 degrees apart around the cask body as shown (see, e.g., FIG. 9); however, a greater or few number may be provided in other implementations of the cask. The lifting rib plates 160a provide a load transfer interface with the lid 150.

Lid 150 is a radiation shielding structure with outer metallic casing (e.g., steel) comprising a circular top plate 151, opposing circular bottom plate 152, and a cylindrical outer lid shell 153 welded to the top plate and the bottom plate of the lid forming an internal cavity 154. Cavity 154 is filled with radiation shielding material 107, which may comprise concrete in some embodiments. Various other shielding materials and combinations thereof may be used as previously described herein with respect to the cask radiation shielding.

Lid 150 further comprises a plurality of radially/laterally elongated lid lifting plates 155, which may be arranged in an orthogonal cruciform pattern intersecting at the center of the lid (see, e.g., FIGS. 10, 15, and 16). The lifting plates are embedded in the concrete fill and comprise a lifting lug 156 protruding upwards beyond the top plate 151. Lifting lugs 156 are configured with holes for rigging to an overhead hoist or crane for raising, lowering, and transporting the unventilated storage cask 100. Accordingly, lifting plates 155 may be welded to the top plate 151, bottom plate 152, and/or outer shell 153 to provide a rigid skeletal frame for the lid 150 capable of handling the cask 100 which generally weights in excess of 100 tons.

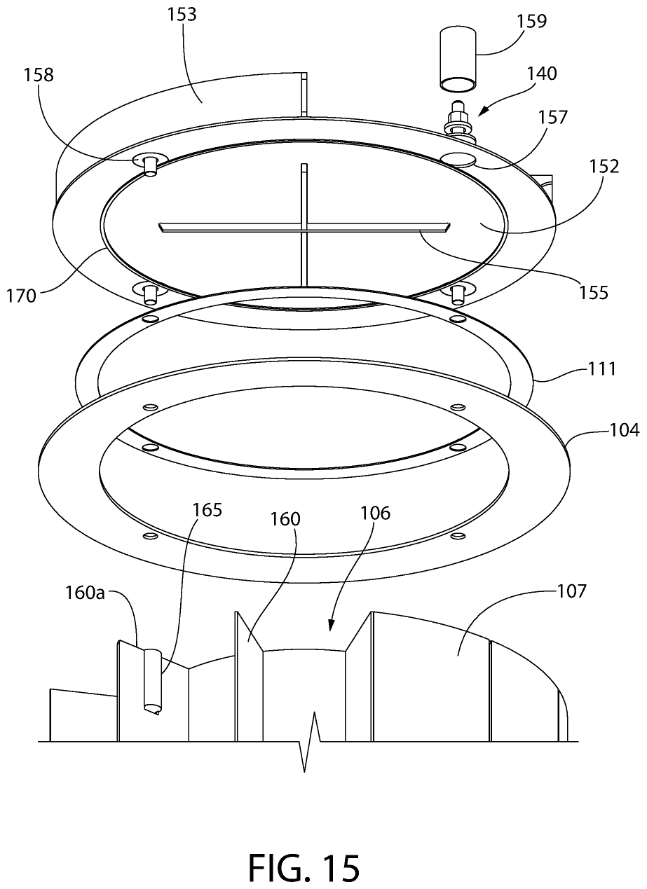

Importantly, the lifting plates 155 and the foregoing welded lid construction further act as a heat transfer mechanism to dissipate heat emitted by the canister 120 in the cask cavity 105 through the lid to the ambient environment. To further enhance heat transfer, the lifting plates may penetrate the bottom plate 152 of lid 150 for direct exposure to the cask cavity 105 (see, e.g. FIG. 15). Lifting plates may protrude downwards below the bottom surface of the bottom lid plate in some embodiments as shown for this purpose and also to vertical stabilize the canister 120 within the cask against vertical movement either during transport of the cask or a seismic event.

By virtue of the thermosiphon effect occurring inside the waste fuel canister 120 (e.g., MPC) through the fuel basket 123, the top lid 125 of the canister seen in FIG. 13 is the hottest part of the canister's exterior surface. The hot canister heated by heat emitted by the decaying spent fuel assemblies therein rejects heat to the bottom plate 152 of the cask's closure lid 150 directly above and proximate to the top of the canister by direct radiation and convection. The lid lifting plates 155 and the physical connectivity they provide between the bottom plate 152 and top plate 151 of the lid directly exposed to the ambient environment thus are important to the cask's thermal performance for cooling the canister. From a personnel safety standpoint, having the hottest surface of the cask (i.e., lid 150) located at the very top of the cask (away from the reach of surveillance personnel) is an advantageous operational feature of the nuclear waste fuel storage system.

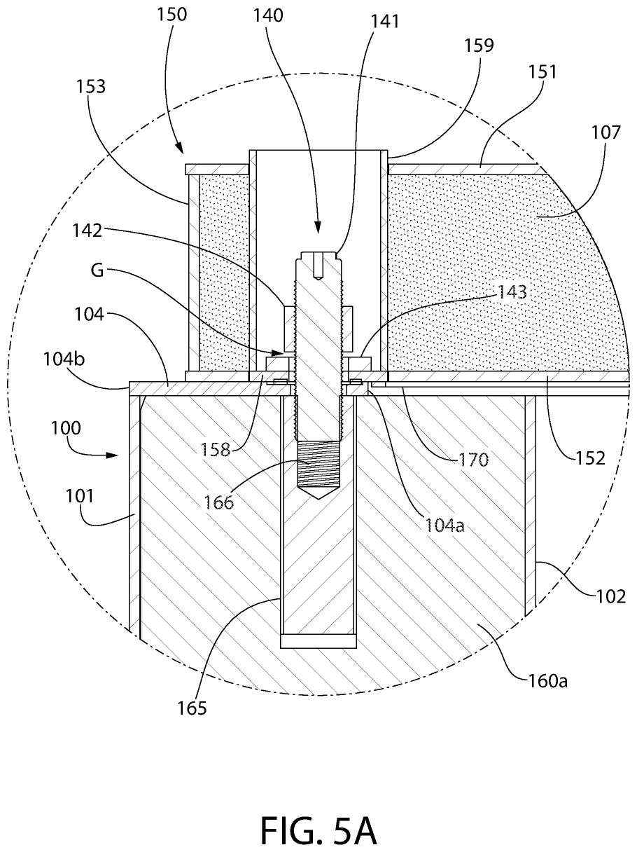

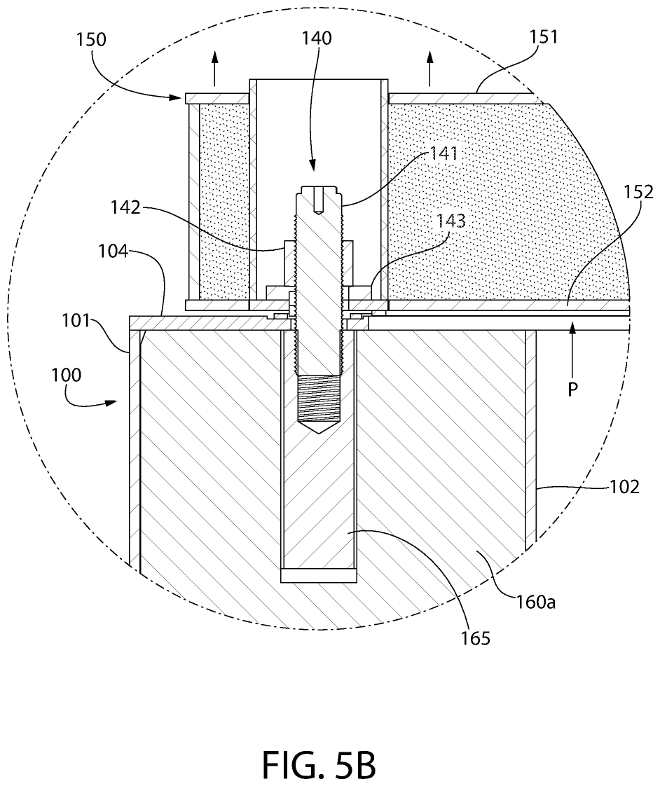

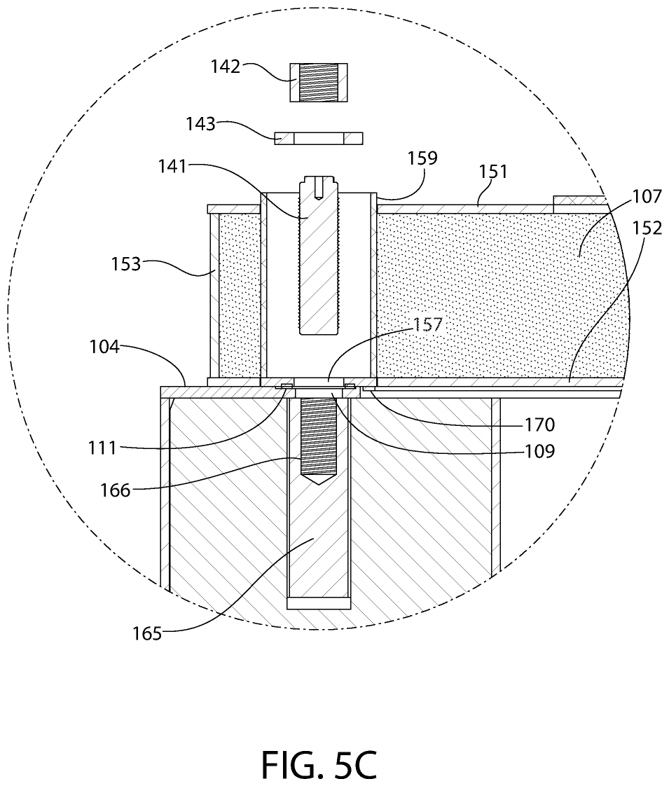

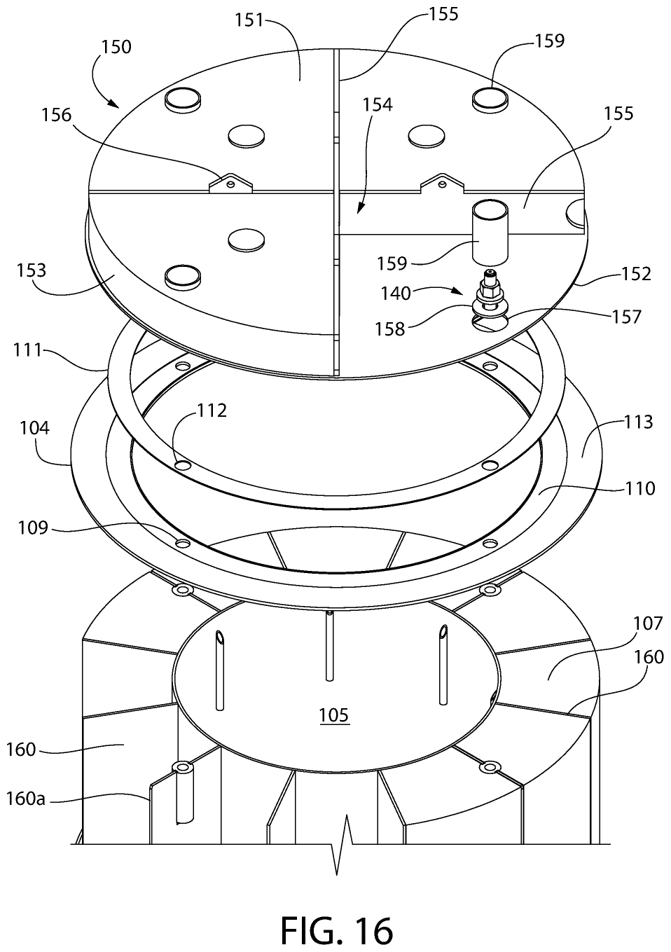

Referring specifically to FIGS. 5B and 16, bottom plate 152 of the lid 150 comprises a plurality of circumference lid fastener holes 157 arranged to be concentrically aligned with fastener holes 109 of cask top closure plate 104 and threaded bosses 165 of lifting rib plates 160a. Each lid fastener hole 157 is accessible through a respective access tube 159 welded to bottom plate 152. Access tubes 159 project upwards passing through lid top plate 151, and preferably protruding beyond and above the top plate as shown to prevent the ingress of standing water from the top surface of the lid into the tube. The access tubes are formed of steel, preferably stainless steel to prevent corrosion and accumulation of rust which might adversely affect the sliding motion of the floating lid along the bolt assemblies 140 (e.g., the threaded studs 141). The tubes 159 be further be welded to the top plate 51 in some embodiments. Access tubes 159 are embedded in the concrete radiation shielding material in the lid 150 (see, e.g., FIGS. 5A and 16).

For cask lid constructions where the bottom closure plate may be formed of steel which may corrode and rust, an annular hole insert plate 158 may optionally be used which is formed of stainless steel similarly to the bolting assembly access tubes 159. The hole insert plate is welded partially or fully around its circumference to the lid bottom plate to eliminate any pressure passage into the interior of the lid. The fastener holes 157 of lid 150 in this case are formed by the hole insert plates. In other embodiments, however, the insert plates 158 may be omitted and fastener holes 157 may be formed directly in the lid bottom plate 152 within the access tubes 159. Either construction may be used. The use of stainless steel to construct the access tubes 159, hole insert plates 158, and preferably the bolting assembly 140 components mitigates the formation of rust which might interfere with smooth sliding movement of the floating lid 150 along the bolt assemblies during cask overpressurization conditions. This is an exposure since rainwater will tend to accumulate inside the access tubes 159 until the heat dissipated through the lid 150 from the internal cavity 107 of cask 100 eventually evaporates the water.

Referring to FIGS. 5A-C and 15-16, the threaded bolt assemblies 140 each include a cylindrical threaded stud 141 threadably engageable with the anchor bosses 165 (i.e., threaded bore 166) of the lifting rib plates 160 through the top closure plate 104 of the cask 100, an internally threaded adjustable limit stop 142 rotatably coupled to the stud for upward/downward positioning thereon, and optionally a washer 143 which receives the stud. In one embodiment, the limits stop 142 may be a threaded hex nut adjustable in position along the threaded stud to change a height of an installer-adjustable vertical travel gap G formed between the limit stop and bottom plate 152 of the lid 150. Where the optional washer 143 is provided, travel gap G is formed between the top of the washer and the bottom surface of the lid bottom plate. Travel gap G defines a range of vertical travel of the lid along stud 141. In some embodiments, travel gap G may be about ⅜ inch or more. Even such a small gap between the lid when raised and the cask body is effective to relieve excess internal pressure from the cask. Accordingly, lid 150 is vertically movable relative to the cask body within a range defined by the travel gap. The forgoing bolt assembly components (stud, limit stop, and washer) are preferably formed of stainless steel to prevent corrosion and rust formation on the threaded stud 141 which might inhibit the lid from freely sliding along the studs when rising during a cask overpressurization condition.

To provide a self-regulating cask overpressurization relief system, the radiation shielding lid 150 is a free-floating design which is movably coupled to the top end of the cask 100 in a hermetically sealable manner by bolt assemblies 140. Accordingly, the bolt assemblies 140 are configured to loosely mount the lid to the cask body, thereby allowing limited vertical movement of the lid relative to the cask body via the foregoing installer-positionable limit stops 142 of the bolt assemblies to adjust the travel gap G. The weight of the lid acts in conjunction with the annular compressible gasket 111 which forms a circumferential seal between the lid and the top end of the cask body to maintain a hermetic seal of the cask body. This forms the gas tight cavity 105 which houses canister 120 under normal cask operating pressures. The cask 100 is therefore operable to retain an internal pressure within the gas tight cavity 105 above atmospheric pressure. When the internal pressure P of the cask acting on the bottom surface area of the lid bottom plate 152 exposed to the cask cavity 105, this creates an upward acting lifting force which exceeds the weight of the lid, the lid will rise and become slightly ajar from the top closure plate 104 of the cask to relieve the cask excess pressure (see, e.g., FIG. 5B).

Lid 150 may further comprise a metallic raised annular shear ring 170 protruding downwardly from a bottom surface of the lid bottom plate 152. The shear ring is designed such that if the cask 100 tips over, the lid will contact the cask body top plate 104 to absorb the shear forces instead of the bolt assemblies 140. This protects the structural integrity and lid-to-cask seal of the cask cavity 105. Shear ring 170 is arranged proximate to a circumferential inner edge 104a of the top closure plate 140 as shown in FIG. 5A for mutual engagement therebetween in the event of a cask tipping event.

Lid 150 is slideably movable in a vertical direction by a limited amount along the bolt assemblies 140 (i.e., threaded stud 141 particularly) dictated by travel gap G. Lid 150 is movable between: (1) a downward sealed position engaged with the cask body which seals the gas tight cavity of the cask (see, e.g., FIG. 5A); and (2) an adjustable raised relief position engaged with the bolt assemblies but ajar from the cask body to partially open the gas tight cavity thereby defining a gas overpressurization relief passageway to ambient atmosphere extending circumferentially and perimetrically around the top end of the cask body (FIG. 5B).

When an internal cask overpressurization condition occurs, the lid 150 rises under pressure P to close the travel gap G and engage the threaded limit stop 142 on stud 141 with the bottom plate 152 of the lid which arrests upward movement of the lid. The heating of the trapped volume of gas in the cask cavity 105 (i.e., air or an inert gas pumped into the cask cavity after placement of and sealing by the lid) by the fuel assemblies stored within the SNF canister 120 will on its own cause an increase in internal cask pressure P to the point limited by the weight of the free-floating lid. Such an overpressurization condition may also be associated with spent nuclear fuel dry storage system (i.e., cask) Design Basis Fire Event, or other abnormal operating condition within the cask. The U.S. NRC (Nuclear Regulatory Commission) mandates dry storage systems to meet stringent safety requirements at all times, including during the occurrence of postulated cask design basis accident events. A design basis accident is any event that could significantly affect the integrity of the storage system, such as an external fire, fuel rod rupture, and natural phenomena such as earthquakes, lightning strikes, projectile impacts, and others.

When the cask overpressurization condition abates, the relieved internal cask pressure drops back down within the cask and lid 150 automatically returns to the downward position under its own weight to re-engage the cask body and reseal the gas tight hermetically sealed cavity 105. In the event an overpressurization condition occurs again, the lid 150 will again rise to relieve the excess pressure and repeat the cycle without manual intervention, thereby forming a self-regulating cask overpressurization relief system.

In view of the foregoing, a method or process for protecting an unventilated nuclear fuel storage cask from internal overpressurization will now be briefly summarized. The method includes providing the unventilated cask 100 comprising the sealable internal cavity 105 and a plurality of threaded anchor bosses 165. The cavity of the cask remains upwardly open at this juncture. The method continues with lowering canister 120 containing high level nuclear waste into the cavity 105, and then positioning the radiation shielded lid 150 on the cask. The lid is now in the downward sealed position engaged with the cask thereby making the cavity gas tight to retain pressures exceeding atmospheric. The method continues with aligning the plurality of fastener holes 109 formed in the lid 150 (e.g., in lid bottom plate 152) with the anchor bosses. Next, the method includes threadably engaging a threaded stud 141 of the bolt assemblies 140 with each of the cask anchor bosses 165 through the fastener holes 109 of the lid, and then rotatably engaging a threaded limit stop 142 with each of the threaded studs. This last step may be preceded by sliding a washer 143 over each threaded stud 141 to rest on the lid (e.g., lid bottom plate 152 at the base of access tubes 159) if washers are optionally used. The final step comprises rotating and positioning the limits stops 142 on the studs 141 such that a vertical travel gap G is formed between the lid and the limit stops. This position of the lid 150 is shown in FIG. 5A. During a cask overpressurization condition wherein the upward force exerted on the bottom surface of the free-floating lid 150 by the internal pressure of the cask exceeds the weight of the lid, the lid slideably moves upward along the studs 141 to the relief position ajar from the cask to vent excess pressure to atmosphere. As previously described herein, when the cask overpressurization condition abates, the lid automatically returns to the downward position to re-engage the cask body and reseal the gas tight cavity for continued operation.

In some embodiments, the pressure of the cask cavity 105 which holds the waste fuel canister 120 air may be reduced to a low enough value such that it will remain below the ambient pressure under all service conditions. To ensure that the cask operates under sub-atmospheric conditions, it would be necessary to pump out the ambient air in the cask cavity 105 after the canister 120 and lid 150 are in place. Typically, an initial pressure of about ½ atmosphere would generally be sufficient to ensure that the internal pressure of the cask 100 remains sub-atmospheric under all operating conditions. Suitable piping connections and valving may be provided to pump the air out of the cask and establish the sub-atmospheric cask operating pressure. The cask cavity 105 may next be optionally filled with an inert gas after mounting the lid 150 to the cask 100 in some embodiments. This added safety measure to protect the long term integrity of the canister confinement barrier may be used where the onset of SCC at the exterior surfaces of the canister 120 may be an operational issue.

While the foregoing description and drawings represent some example systems, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. An unventilated nuclear waste fuel storage system comprising:
a longitudinal axis;
a waste fuel canister configured for storing nuclear fuel inside;
an outer cask comprising a cask body including an inner shell, an outer shell, an annular space containing a radiation shielding material formed between the shells, and a bottom baseplate sealed to bottom ends of the shells;
a radiation shielding lid selectively sealable to the cask body, the lid when positioned on the cask body collectively defining a gas tight cavity receiving the canister;
a plurality of longitudinal lifting rib plates extending radially between and fixedly attached to the inner and outer shells in the annular space, each lifting rib plate comprising a threaded anchor boss fixedly attached at a top end thereof; and
a plurality of threaded bolt assemblies threadably engaged with the anchor bosses which secure the lid to the cask;
wherein the gas tight cavity forms a pressure vessel operable to retain pressures above atmospheric pressure within the cask.

2. The system according to claim 1, wherein the lifting rib plates extend for a full longitudinal height of the annular space from the baseplate to a top end of the cask body.

3. The system according to claim 2, wherein the lifting rib plates are flat sheet-like rectangular structures welded to at least the inner and outer shells along opposing longitudinal edges of the lifting rib plates.

4. The system according to claim 2, further comprising a plurality of intermediate rib plates arranged between the lifting rib plates, the intermediate rib plates extending radially between and fixedly attached to the inner and outer shells in the annular space of the cask and extending for a full height thereof.

5. The system according to 3, further comprising an annular top closure plate welded to a top end of the outer shell of the cask, the top closure plate projecting radially inwards from the outer shell and comprising a plurality of fastener holes which receive the bolt assemblies therethrough to engage the anchor bosses of the lifting rib plates.

6. The system according to claim 5, wherein the top closure plate projects radially towards but does not contact the inner shell of the cask to partially close the annular space between the shells of the cask body.

7. The system according to claim 6, wherein the fastener holes are formed through an annular recessed gasket seating surface of the top closure plate.

8. The system according to claim 7, further comprising a compressible annular gasket seated on the gasket seating surface, the gasket compressed between the top closure plate of the cask and a bottom plate of the lid.

9. The system according to claim 8, wherein the gasket comprises a plurality of fastener apertures concentrically aligned with the fastener holes of the top closure plate to receive the bolt assemblies therethrough.

10. The system according to claim 6, wherein the lid further comprises a raised annular shear ring extending downwardly from a bottom surface of the lid, the shear ring arranged proximate to and engageable with a circumferential inner edge of the top closure plate during a cask tipping event.

11. The system according to claim 5, wherein the lid is a free-floating design such that the bolt assemblies are configured to loosely mount the lid to the cask body allowing limited vertical movement of the lid relative to the cask body, a weight of the lid acting to seal the lid to the cask body to form the gas tight cavity.

12. The system according to claim 11, wherein the lid is slideably movable by a limited amount along the bolt assemblies between: (1) a downward sealed position engaged with the cask body which seals the gas tight cavity of the cask; and (2) an adjustable raised relief position engaged with the bolt assemblies but ajar from the cask body to partially open the gas tight cavity thereby defining a gas overpressurization relief passageway to ambient atmosphere.

13. The system according to claim 12, wherein each of the bolt assemblies comprise:
a threaded stud threadably engaged with the anchor bosses of the lifting rib plates through the top closure plate of the cask, and
an adjustable limit stop rotatably coupled to the stud and forming an adjustable vertical travel gap between the limit stop and a bottom plate of the lid;
wherein the lid is vertically movable relative to the cask body within a range defined by the travel gap.

14. The system according to claim 13, wherein the limit stop is a threaded nut adjustable in position along the threaded stud to change a height of the vertical travel gap and travel range of the lid.

15. The system according to claim 13, wherein when a cask overpressurization condition occurs, the lid rises to close the travel gap and engage the limit stop with the bottom plate of the lid to arrest upward movement of the lid.

16. The system according to claim 15, wherein when the cask overpressurization condition abates, the lid automatically returns to the downward position to re-engage the cask body and reseal the gas tight cavity.

17. The system according to claim 1, wherein the lid further comprises a top plate, and a cylindrical outer lid shell welded to the top plate and the bottom plate of the lid forming an internal cavity filled with radiation shielding material comprising concrete.

18. The system according to claim 17, wherein the lid further comprises a plurality of radially elongated lid lifting plates arranged in a cruciform pattern, the lid lifting plates embedded in the concrete and comprising a lifting lug protruding upwards beyond the top plate of the lid.

19. The system according to claim 17, wherein the lid comprises a plurality of upwardly open fastener access tubes extending vertically through the top lid plate to the bottom lid plate, the bolt assemblies disposed and accessible within the access tubes.

20. The system according to claim 19, wherein the bottom plate of the lid comprises a lid fastener hole within each the access tubes, the bolt assemblies received through the lid fastener holes and the fastener holes of the top closure plate of the cask to threadably engage the anchor bosses of the lifting rib plates.

21. The system according to claim 1, wherein the anchor bosses each comprise a cylindrical body defining an upwardly open threaded bore engageable with the threaded bolt assemblies.

22. An unventilated nuclear waste fuel storage pressure vessel with self-regulating internal pressure relief mechanism, the pressure vessel comprising:
a longitudinal axis;
a cask body including an inner shell, an outer shell, an annular space containing a radiation shielding material formed between the shells, a bottom baseplate sealed to bottom ends of the shells, and an internal cavity configured to house a nuclear waste fuel canister therein;
a plurality of upwardly open threaded anchor bosses affixed to a top end of the cask body;
a radiation shielding lid loosely coupled to the top end of the cask body in a movable manner;
an annular compressible gasket forming a circumferential seal between the lid and the top end of the cask body which renders the cavity gas tight; and
a plurality of bolt assemblies passing through the lid and threadably engaged with the anchor bosses, the bolt assemblies configured and operable to loosely secure the lid to the cask body;
the lid being movable between (1) a downward sealed position engaged with the cask body, which seals the gas tight cavity of the cask; and (2) an adjustable raised relief position engaged with the bolt assemblies but ajar from the top end of the cask body to partially open the gas tight cavity thereby defining a gas overpressurization relief passageway to ambient atmosphere;
wherein the cask is operable to retain an internal pressure within the cavity above atmospheric pressure.

23. The pressure vessel according to claim 22, wherein each of the bolt assemblies comprise:
a threaded stud threadably engaged with the anchor bosses of the lifting rib plates through the top closure plate of the cask, and
an adjustable limit stop rotatably coupled to and movable along the stud to form an adjustable vertical travel gap between the limit stop and a bottom plate of the lid;
wherein the lid is vertically movable relative to the cask body within a range defined by the travel gap.

24. The pressure vessel according to claim 23, wherein when a cask overpressurization condition occurs, the lid rises to close the travel gap and engage the limit stop with the bottom plate of the lid to arrest upward movement of the lid.

25. The pressure vessel according to claim 24, wherein when the cask overpressurization condition abates, the lid automatically returns to the downward position to re-engage the cask body and reseal the gas tight cavity.

26. The pressure vessel according to claim 22, wherein the lid rises to the upward raised relief position when the internal pressure of the cask creates an upward force on the lid which exceeds a weight of the lid.

27. A method for protecting an unventilated nuclear waste storage system from internal overpressurization, the method comprising:
providing an unventilated cask comprising a sealable internal cavity and a plurality of threaded anchor bosses;
lowering a canister containing high level nuclear waste into the cavity;
positioning a radiation shielded lid on the cask, the lid being in a downward sealed position engaged with the cask making the cavity gas tight to retain pressures exceeding atmospheric;
aligning a plurality of fastener holes formed in the lid with the anchor bosses;
threadably engaging a threaded stud with each of the anchor bosses through the fastener holes of the lid;
rotatably engaging a threaded limit stop with each of the threaded studs;
positioning the limits stops on the studs such that a vertical travel gap is formed between the lid and the limit stops;
wherein during a cask overpressurization condition, the lid slideably moves upward along the studs to a relief position ajar from the cask to vent excess pressure to atmosphere.

28. The method according to claim 27, wherein when the cask overpressurization condition abates, the lid automatically returning to the downward sealed position to re-engage the cask body and reseal the cavity.

29. The method according to claim 27, further comprising pumping air out of the cavity of the cask after positioning the lid on the cask to establish a sub-atmospheric pressure in the cavity.

30. The method according to claim 29, further comprising filing the cavity of the cask with an inert gas.
